(19) United States
(12) Patent Application Publication
(10) Pub. No.: US 2005/0237663 A1
(43) Pub. Date: Oct. 27, 2005

(54) Insulator with pocket features

(75) Inventor: Long V. Nguyen, San Jose, CA (US)

Correspondence Address: MICHAEL B. EINSCHLAG, ESQ., 25680 FERNHILL DRIVE, LOS ALTOS HILLS, CA, 94024, US

(73) Assignee: Riospring, Inc., Milpitas, CA (US)

(21) Appl. No.: 11/108,276

(22) Filed: Apr. 18, 2005

Related U.S. Application Data
(60) Provisional application No. 60/564,351, filed on Apr. 21, 2004.

(51) Int. Cl. G11B 17/00

(52) U.S. Cl. 360/97.01; 428/901

(57) ABSTRACT

One embodiment of the present invention is an insulator that includes a pocket feature adapted to accommodate at least a portion of one or more components disposed on a printed circuit board.

This application claims the benefit of U.S. Provisional Application No. 60/564,351, filed on Apr. 21, 2004 and which is incorporated herein by reference.

### TECHNICAL FIELD OF THE INVENTION

One or more embodiments of the present invention relate to electronic devices, and more particularly, to an insulator for printed circuit boards in electronic devices.

### BACKGROUND OF THE INVENTION

An electronic device generally includes one or more insulators to avoid electrical shorts. Considering a hard disk drive (HDD) as an example, in a head disk assembly (HDA) of an HDD, a printed circuit board (PCB) is typically connected to an HDA platform, which HDA platform is typically made of stainless steel or aluminum. To avoid electrical shorts, a flat, mylar® sheet insulator or a flat, kapton® sheet insulator is typically sandwiched between the PCB and the HDA platform. Such flat insulators, however, may cause reliability problems in electronic devices, especially in small form factor electronic devices.

Small form factor electronic devices, for example and without limitation, small form factor HDDs, utilize small, thin PCBs. As is well known, for a small form factor HDD, many components need to be disposed on the PCB and on the HDA platform. As is further well known, components disposed on the PCB are typically soldered to the PCB with fine, fragile solder. Because of this, distortion in, or bending of, the PCB may break these solder joints, and thereby cause unreliable electrical connections.

Conventionally, to minimize the overall height of an HDD and to comply with form factor specifications such as, for example and without limitation, CFII, the HDA platform includes clearance pocket features such as, for example and without limitation, clearance pockets. Such clearance pocket features enable components on the PCB to be disposed therein, thereby eliminating at least portions of the heights of the components from the overall HDD height. However, whenever a small form factor HDD is assembled with a conventional, flat insulator being disposed between the PCB and the HDA platform, the flat insulator may be pushed by the relatively stiffer HDA platform (at least at the edges of the clearance pockets). Such pushing may exert excessive force and stress on PCB components in contact therewith, and such excessive force and stress might bend the PCB. Such bending may cause breaking of solder joints of PCB components on the PCB. As a result, the HDD might malfunction.

In light of the above, there is a need in the art for an insulator that solves one or more of the above-identified problems.

### SUMMARY OF THE INVENTION

One or more embodiments of the present invention solve one or more of the above-identified problems. In particular, one embodiment of the present invention is an insulator that includes a pocket feature that is adapted to accommodate at least a portion of one or more components disposed on a printed circuit board.

### BRIEF DESCRIPTION OF THE DRAWING

FIGS. 1A and 1B show a top perspective view and a bottom perspective view, respectively, of a typical printed circuit board (PCB) used in a disk drive;

FIG. 2 shows an insulator that is fabricated in accordance with one or more embodiments of the present invention; and

FIG. 3 shows top perspective exploded views of a disk drive which indicate relative positions of a PCB cover, an insulator, the PCB shown in FIG. 1, the insulator shown in FIG. 2 that is fabricated in accordance with one or more embodiments of the present invention, and a head disk assembly platform (HDA platform).

### DETAILED DESCRIPTION

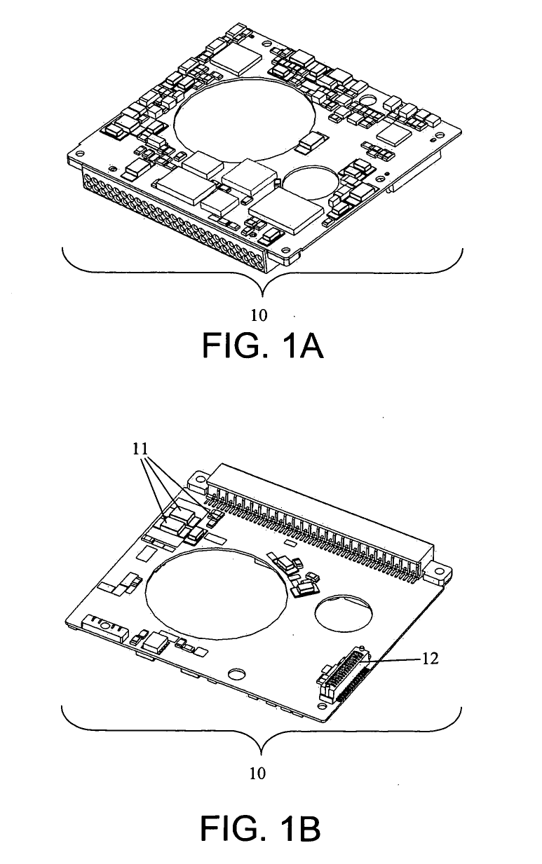

FIGS. 1A and 1B show a top perspective and a bottom perspective view, respectively, of printed circuit board 10 (PCB 10) that is used in a disk drive. Components 11 are installed on PCB 10 to provide various functions in the disk drive such as control and signal processing. Components 11 are soldered onto PCB 10 with fine, fragile solder. Because of this, distortion in, or bending of, PCB 10 may break these solder joints, and thereby cause unreliable electrical connections between PCB 10 and components 11. In a typical disk drive, PCB 10 may have a thickness of about 0.4 mm, and components 11 may have a height of about 1 mm above the surface of PCB 10.

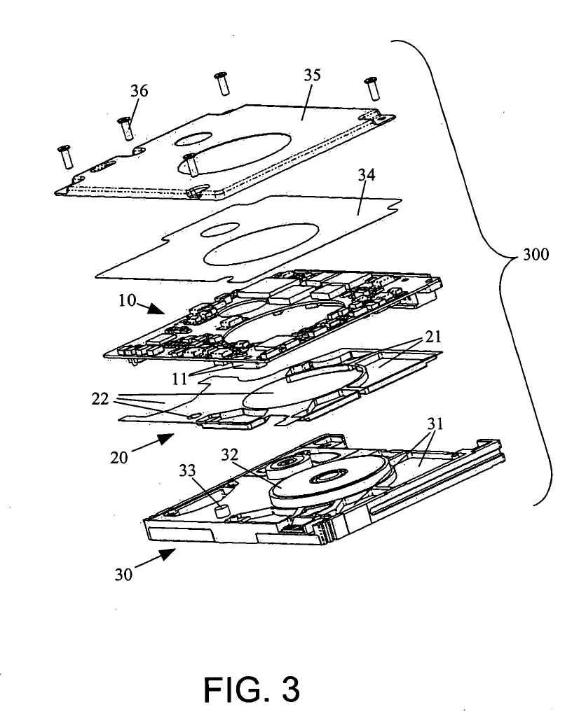

As further shown in FIG. 1, connector 12 disposed on PCB 10 provides electrical connections between PCB 10 and head disk assembly platform 30 (HDA platform 30) that is shown in FIG. 3.

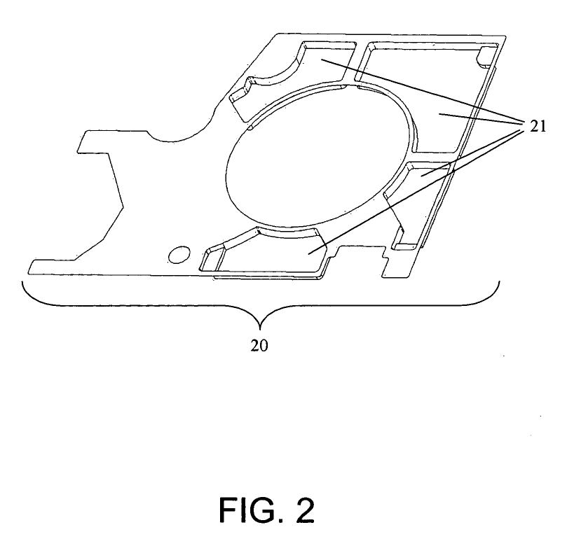

FIG. 2 shows insulator 20 that is fabricated in accordance with one or more embodiments of the present invention. As shown in FIG. 2, insulator 20 includes pocket features 21 that provide space in which to accommodate at least a portion of components 11 shown in FIG. 1 in a manner that will be described below. Advantageously, in accordance with one or more embodiments of the present invention, because pocket features 21 can accommodate at least a portion of components 11, whenever disk drive 300 is assembled in the manner described below, insulator 20 exerts little stress on components 11. This is to be contrasted with the stress exerted by a conventional, flat insulator, which stress may be large enough to cause distortion in, or bending of, PCB 10 and thereby subsequent breaking of solder joints between components 11 and PCB 10.

FIG. 3 shows top perspective exploded views of disk drive 300 which indicate relative positions of PCB cover 35, insulator sheet 34, PCB 10, insulator 20 that is fabricated in accordance with one or more embodiments of the present invention, and HDA platform 30. As one can readily appreciate from FIG. 3, to assemble the parts shown therein, screw 36 would be: (a) extended through screw holes on PCB cover 35 and PCB 10; and (b) fastened in a screw receptacle in HDA platform 30. This would align and fasten PCB cover 35, PCB 10, and HDA platform 30, with (a) insulator sheet 34 being sandwiched between PCB cover 35 and PCB 10; and (b) insulator 20 being sandwiched between HDA platform 30 and PCB 10. In accordance with one or more embodiments of the present invention, a plurality of screws and corresponding screw holes and screw receptacles may be used with effects that are similar to that of screw 35 and its corresponding screw holes and screw receptacle. As one of ordinary skill in the art can readily appreciate, in accordance with one or more embodiments of the present invention, during assembly of disk drive 300, as screw 36 (and any other screws that are utilized) is tightened, it exerts a force that urges the parts towards each other to complete the assembly.

As shown in FIG. 3, pocket features 21 of insulator 20 are aligned with pocket features 31 of HDA platform 30 to provide space in which at least portions of components 11 are disposed when disk drive 300 is assembled. As a result, contact between electrical components disposed on PCB 10 and insulator 20 is reduced or eliminated. As one can readily appreciate from FIGS. 2 and 3, in accordance with one or more embodiments of the present invention, pocket features 21 include a circumscribing (or wall) portion that is adapted to insulate lateral portions of components 11 from HDA platform 30. In accordance with one or more embodiments of the present invention, when insulator 20 is assembled with PCB 10, the circumscribing portions of pocket features 21 are substantially perpendicular to PCB 10 so that the circumscribing portions: (a) transmit no, or minimized, normal force from HDA platform 30 to components 11; and (b) support components 11 against movement or deformation. However, other embodiments exist wherein the circumscribing portions may be disposed at an angle to PCB 10 other than ninety degrees so long as the circumscribing portions provide the functionality described above.

Further, as one can readily appreciate from FIGS. 2 and 3, in accordance with one or more embodiments of the present invention, pocket features 21 each include a bottom portion that is adapted to insulate tops of components 11 from HDA platform 30. In accordance with one or more embodiments of the present invention, the bottom portion of each of pocket features 21 includes one or more substantially flat areas (as shown in FIG. 2), and when insulator 20 is assembled with PCB 10, the bottom portion of each of such pocket features 21 is substantially parallel to PCB 10 to minimize the height of disk drive 300. Further, in accordance with one or more embodiments of the present invention, pocket features 21 have sufficient depth so that there is negligible or no contact with the tops of components 11 when the disk drive is assembled. Still further, the configurations of the various ones of pocket features 21 are determined by a requirement that: (a) the pocket features fit into corresponding pocket features of HDA platform 30, and (b) they provide enough space to encompass at least portions of predetermined ones of components 11.

In accordance one or more embodiments of the present invention, insulator 20 includes an insulating material. For example, such insulating material may be an insulating material that is well known in the art such as, for example and without limitation, 1 mil thick mylar® or kapton® that is UL (Underwriters Laboratories Inc.) approved. Further, in accordance with one or more embodiments of the present invention, insulator 20 may comprise a compliant material. Still further, in accordance with one or more embodiments of the present invention, insulator 20 may comprise non-conductive coating. Further, in accordance with one or more embodiments of the present invention, pocket features 21 are fabricated using one or more forming processes that are well known to one of ordinary skill in the art such as, for example and without limitation, vacuum forming, heat forming, or stamping.

In accordance with one or more further embodiments of the present invention, insulator 20 may include one or more openings 22 that enable one or more components of PCB 10 or HDA platform 30 to extend through insulator 20. In accordance with one or more such embodiments of the present invention, components that extend through openings 22 of insulator 20 include, for example and without limitation, connector 12 (as shown in FIG. 1), spindle motor housing 32, and alignment pin 33. Further, in accordance with one or more embodiments of the present invention, openings 22 are fabricated by using one or more cutting or forming processes that are well known in the art such as, for example and without limitation, die cutting.

As shown in FIG. 3, in contrast to insulator 20, insulator sheet 34 may be flat, i.e., without pocket features, given that PCB cover 35 provides room for components on PCB 10 without pushing on insulator sheet 34.

Advantageously in accordance with one or more embodiments of the present invention, an electronic device, for example and without limitation, a disk drive, that utilizes one or more insulators that are fabricated in accordance with one or more embodiments of the present invention may have high dimensional conformity of parts as well as minimum stress on components and printed circuit board(s), and therefore have reliable electrical connection and quality.

The embodiments of the present invention described above are exemplary. Many changes and modifications may be made to the disclosure recited above, while remaining within the scope of the invention. The scope of the invention should, therefore, be determined not with reference to the above description, but instead should be determined with reference to the appended claims along with their full scope of equivalents.

1. An insulator comprising a pocket feature that is adapted to accommodate at least a portion of one or more components disposed on a printed circuit board.

2. The insulator of claim 1 comprising mylar®.

3. The insulator of claim 1 comprising kapton®.

4. The insulator of claim 1 comprising a compliant material.

5. The insulator of claim 1 comprising a non-conductive coating.

6. The insulator of claim 1 wherein the printed circuit board is a part of a disk drive.

7. The insulator of claim 1 further comprising at least one opening.

8. The insulator of claim 1 comprising a plurality of pocket features.

9. The insulator of claim 1 wherein the pocket feature comprises a substantially flat area.

10. The insulator of claim 1 wherein a portion of the pocket feature is substantially perpendicular to the printed circuit board when the insulator is assembled with the printed circuit board in an electronic device.

11. The insulator of claim 1 wherein a portion of the pocket feature is substantially parallel to the printed circuit board when the insulator is assembled with the printed circuit board in an electronic device.

12. A device comprising:
a printed circuit board;
a component that is disposed on the printed circuit board; and
an insulator comprising a pocket feature that is adapted to accommodate at least a portion of the component.

13. The device of claim 12 comprising a disk drive.

14. The device of claim 12 being a disk drive.
